(19) United States
(12) Patent Application Publication
(10) Pub. No.: US 2022/0046642 A1
(43) Pub. Date: Feb. 10, 2022

(54) METHOD AND APPARATUS FOR RESOURCE ALLOCATION IN A WIRELESS COMMUNICATION SYSTEM

(71) Applicant: ASUSTek Computer Inc., Taipei City (TW)

(72) Inventor: Ko-Chiang Lin, Taipei City (TW)

(21) Appl. No.: 17/395,797

(22) Filed: Aug. 6, 2021

Related U.S. Application Data
(60) Provisional application No. 63/062,009, filed on Aug. 6, 2020.
(60) Provisional application No. 63/062,037, filed on Aug. 6, 2020.

(51) Int. Cl. H04W 72/04

(52) U.S. Cl. CPC H04W 72/0453; H04W 72/042

(57) ABSTRACT

A method and apparatus are disclosed from the perspective of a User Equipment (UE). In one embodiment, the method includes the UE receiving a configuration of a bandwidth part from a base station. The method also includes the UE deriving a subset of frequency resources within the bandwidth part. The method further includes the UE receiving an indication of a resource allocation for a transmission within the subset of frequency resources.

### CROSS-REFERENCE TO RELATED APPLICATIONS

The present Application claims the benefit of U.S. Provisional Patent Application Ser. Nos. 63/062,009 and 63/062,037 filed on Aug. 6, 2020, the entire disclosures of which are incorporated herein in their entirety by reference.

### FIELD

This disclosure generally relates to wireless communication networks, and more particularly, to a method and apparatus for resource allocation in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a User Equipment (UE). In one embodiment, the method includes the UE receiving a configuration of a bandwidth part from a base station. The method also includes the UE deriving a subset of frequency resources within the bandwidth part. The method further includes the UE receiving an indication of a resource allocation for a transmission within the subset of frequency resources.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Table 4.2-1 of 3GPP TS 38.211 V15.7.0.

FIG. 6 is a reproduction of FIG. 4.3.1-1 of 3GPP TS 38.211 V15.7.0.

FIG. 7 is a reproduction of Table 4.3.2-1 of 3GPP TS 38.211 V15.7.0.

FIG. 8 is a reproduction of Table 4.3.2-2 of 3GPP TS 38.211 V15.7.0

FIG. 9 is a reproduction of Table 4.3.2-3 of 3GPP TS 38.211 V15.7.0.

FIG. 10 is a reproduction of Table 5.1.2.2.1-1 of 3GPP TS 38.214 V16.2.0.

FIG. 11 is a flow chart according to one exemplary embodiment.

FIG. 12 is a flow chart according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems devices described below may be designed to support one or more standards such as the standard offered by a consortium named “3rd Generation Partnership Project” referred to herein as 3GPP, including: TS 38.211 V15.7.0, “NR; Physical channels and modulation (Release 15)”; TS 38.213 V16.2.0, “NR; Physical layer procedures for control (Release 16)”; TS 38.331 V16.0.0, “NR; Radio Resource Control (RRC) protocol specification (Release 16)”; TS 38.214 V16.2.0, “NR; Physical layer procedures for data (Release 16)”; and R1-193259, “New SID: Study on supporting NR from 52.6 GHz to 71 GHz”, Intel Corporation. The standards and documents listed above are hereby expressly incorporated by reference in their entirety.

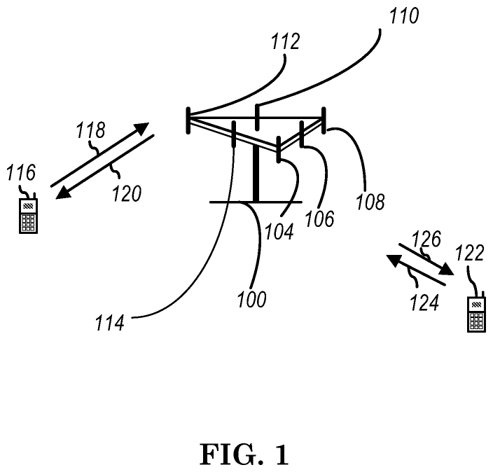

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

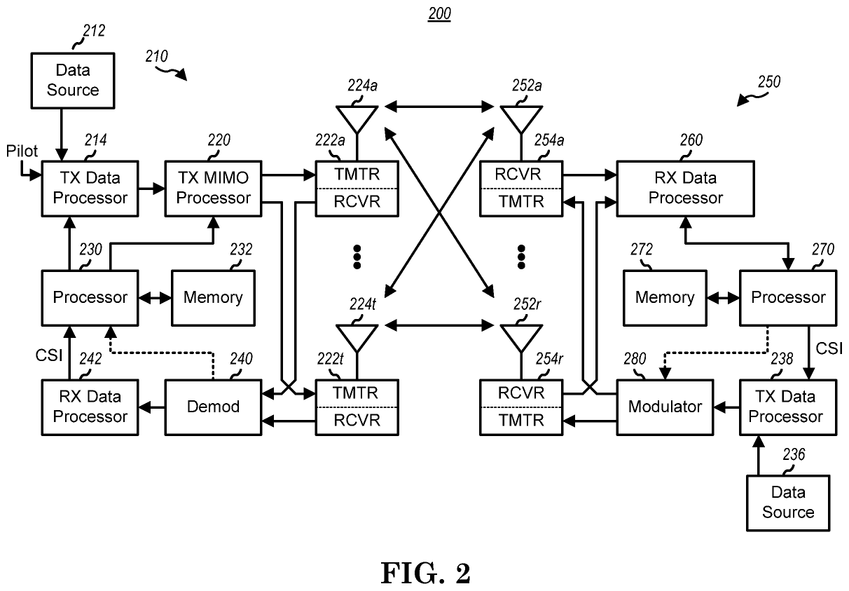

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

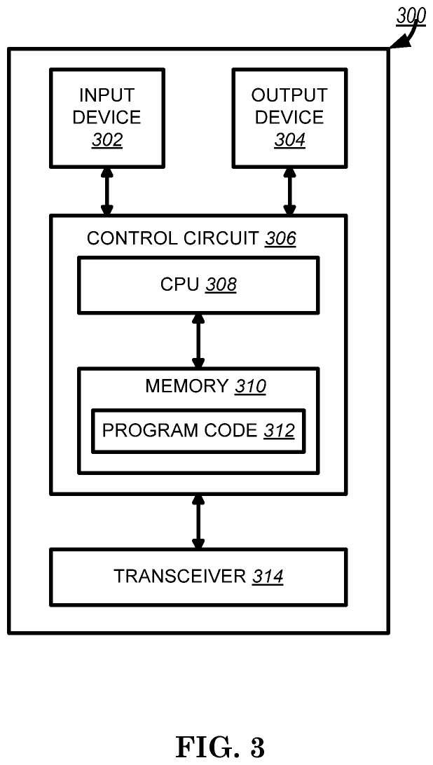

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

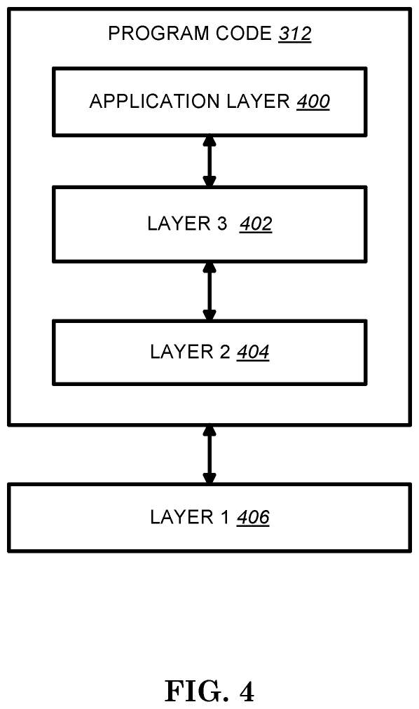

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Frame structure used in New RAT (NR) for 5G, to accommodate various type of requirement (as discussed in 3GPP TS 38.211) for time and frequency resource, e.g. from ultra-low latency (−0.5 ms) to delay-tolerant traffic for Machine Type Communications (MTC), from high peak rate for Enhanced Mobile Broadband (eMBB) to very low data rate for MTC. An important focus of this study is low latency aspect, e.g. short Transmission Time Interval (TTI), while other aspect of mixing or adapting different TTIs can also be considered in the study. In addition to diverse services and requirements, forward compatibility is an important consideration in initial NR frame structure design as not all features of NR would be included in the beginning phase or release.

Reducing latency of protocol is an important improvement between different generations or releases, which can improve efficiency as well as meeting new application requirements, e.g. real-time service. An effective method frequently adopted to reduce latency is to reduce the length of TTIs, from 10 ms in 3G to 1 ms in LTE.

When it comes to NR, the story becomes somehow different, as backward compatibility is not a must. Numerology can be adjusted so that reducing symbol number of a TTI would not be the only tool to change TTI length. Using LTE numerology as an example, it comprises 14 Orthogonal Frequency Division Multiplexing (OFDM) symbol in 1 ms and a subcarrier spacing of 15 KHz. When the subcarrier spacing goes to 30 KHz, under the assumption of same Fast Fourier Transform (FFT) size and same Control Plane (CP) structure, there would be 28 OFDM symbols in 1 ms, equivalently the TTI become 0.5 ms if the number of OFDM symbol in a TTI is kept the same. This implies the design between different TTI lengths can be kept common, with good scalability performed on the subcarrier spacing. Of course there would always be trade-offs for the subcarrier spacing selection (e.g. FFT size, definition/number of PRB, the design of CP, supportable system bandwidth, . . . ). While as NR considers larger system bandwidth, and larger coherence bandwidth, inclusion of a larger sub carrier spacing is a nature choice.

3GPP TS 38.211 provides the following details of NR frame structure, and channel and numerology design:

### 4 Frame Structure and Physical Resources

### 4.1 General

Throughout this specification, unless otherwise noted, the size of various fields in the time domain is expressed in time units T_{c}=1/(Δƒₘₐₓ·N_{f}) where Δƒₘₐₓ=480·10³ Hz and N_{f}=4096. The constant κ=Tₛ/T_{c}=64 where Tₛ=1/(Δƒ_{ref}·N_{f,ref}), Δƒ_{ref}=15·10³ Hz and N_{f,ref}=2048.

### 4.2 Numerologies

Multiple OFDM numerologies are supported as given by Table 4.2-1 where μ and the cyclic prefix for a bandwidth part are obtained from the higher-layer parameter subcarrierSpacing and cyclicPrefix, respectively.

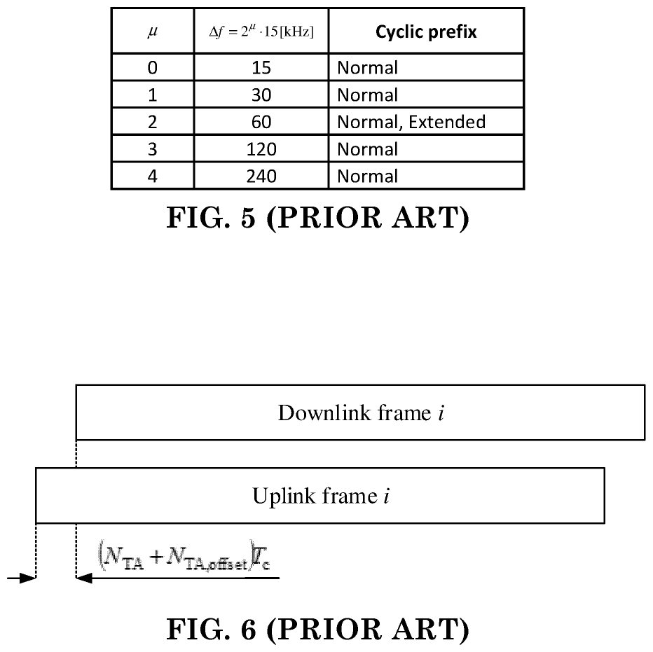

### [Table 4.2-1 of 3GPP TS 38.211 V15.7.0, Entitled “Supported Transmission Numerologies”, is Reproduced as FIG. 5]

### 4.3 Frame Structure

### 4.3.1 Frames and Subframes

Downlink and uplink transmissions are organized into frames with T_{f}=(ΔƒₘₐₓN_{f}/100)·T_{c}=10 ms duration, each consisting of ten subframes of T_{sf}=(ΔƒₘₐₓN_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier. Uplink frame number i for transmission from the UE shall start T_{TA}=(N_{TA}+N_{TA,offset})T_{c} before the start of the corresponding downlink frame at the UE where N_{TA,offset} is given by [5, TS 38.213].

### [FIG. 4.3.1-1 of 3GPP TS38.211 V15.7.0, Entitled “Uplink-Downlink Timing Relation”, is Reproduced as FIG. 6]

### 4.3.2 Slots

For subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where n_{symb}^{slot} depends on the cyclic prefix as given by Tables 4.3.2-1 and 4.3.2-2. The start of slot nₛ^{μ} in a subframe is aligned in time with the start of OFDM symbol nₛ^{μ}N_{symb}^{slot} in the same subframe.

OFDM symbols in a slot can be classified as ‘downlink’, ‘flexible’, or ‘uplink’. Signaling of slot formats is described in subclause 11.1 of [5, TS 38.213].

In a slot in a downlink frame, the UE shall assume that downlink transmissions only occur in ‘downlink’ or ‘flexible’ symbols.

In a slot in an uplink frame, the UE shall only transmit in ‘uplink’ or ‘flexible’ symbols.

A UE not capable of full-duplex communication and not supporting simultaneous transmission and reception as defined by paremeter simultaneousRxTxInterBandENDC, simultaneousRxTxInterBandCA or simultaneousRxTxSUL [10, TS 38.306] among all cells within a group of cells is not expected to transmit in the uplink in one cell within the group of cells earlier than N_{Rx-Tx}T_{c} after the end of the last received downlink symbol in the same or different cell within the group of cells where N_{Rx-Tx} is given by Table 4.3.2-3.

A UE not capable of full-duplex communication and not supporting simultaneous transmission and reception as defined by parameter simultaneousRxTxlnterBandENDC, simultaneousRxTxlnterBandCA or simultaneousRxTxSUL [10, TS 38.306] among all cells within a group of cells is not expected to receive in the downlink in one cell within the group of cells earlier than N_{Tx-RxT}T_{C} after the end of the last transmitted uplink symbol in the same or different cell within the group of cells where N_{Tx-Rx} is given by Table 4.3.2-3.

A UE not capable of full-duplex communication is not expected to transmit in the uplink earlier than N_{Rx-Tx}T_{C} after the end of the last received downlink symbol in the same cell where N_{Rx-Tx} is given by Table 4.3.2-3.

A UE not capable of full-duplex communication is not expected to receive in the downlink earlier than N_{Tx-Rx}T_{C} after the end of the last transmitted uplink symbol in the same cell where N_{Tx-Rx} is given by Table 4.3.2-3.

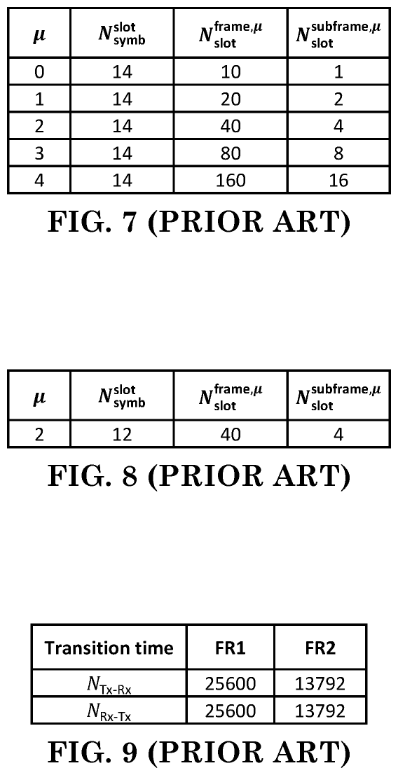

### [Table 4.3.2-1 of 3GPP TS 38.211 V15.7.0, Entitled “Number of OFDM Symbols per Slot, Slots per Frame, and Slots per Subframe for Normal Cyclic Prefix”, is Reproduced as FIG. 7]

### [Table 4.3.2-2 of 3GPP TS 38.211 V15.7.0, Entitled “Number of OFDM Symbols per Slot, Slots per Frame, and Slots per Subframe for Extended Cyclic Prefix”, is Reproduced as FIG. 8]

[Table 4.3.2-3 of 3GPP TS 38.211 V15.7.0, Entitled “Transition Time N_{Rx-Tx} and N_{Tx-Rx}”, is Reproduced as FIG. 9]

### 4.4 Physical Resources

### 4.4.1 Antenna Ports

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same PRG as described in clause 5.1.2.3 of [6, TS 38.214].

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used as described in clause 7.3.2.2.

For DM-RS associated with a PBCH, the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index according to clause 7.4.3.1.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

### 4.4.2 Resource Grid

For each numerology and carrier, a resource grid of N_{grid,x}^{size,μ}N_{sc}^{RB} subcarriers and N_{symb}^{subframe,μ} OFDM symbols is defined, starting at common resource block N_{grid}^{start,μ} indicated by higher-layer signalling. There is one set of resource grids per transmission direction (uplink or downlink) with the subscript x set to DL and UL for downlink and uplink, respectively. When there is no risk for confusion, the subscript x may be dropped. There is one resource grid for a given antenna port p, subcarrier spacing configuration μ, and transmission direction (downlink or uplink).

The carrier bandwidth N_{grid}^{size,μ} for subcarrier spacing configuration μ is given by the higher-layer parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE.

The frequency location of a subcarrier refers to the center frequency of that subcarrier.

For the downlink, the higher-layer parameter txDirectCurrentLocation in the SCS-SpecificCarrier IE indicates the location of the transmitter DC subcarrier in the downlink for each of the numerologies configured in the downlink. Values in the range 0-3299 represent the number of the DC subcarrier and the value 3300 indicates that the DC subcarrier is located outside the resource grid.

For the uplink, the higher-layer parameter txDirectCurrentLocation in the UplinkTxDirectCurrentBWP IE indicates the location of the transmitter DC subcarrier in the uplink for each of the configured bandwidth parts, including whether the DC subcarrier location is offset by 7.5 kHz relative to the center of the indicated subcarrier or not. Values in the range 0-3299 represent the number of the DC subcarrier, the value 3300 indicates that the DC subcarrier is located outside the resource grid, and the value 3301 indicates that the position of the DC subcarrier in the uplink is undetermined.

### 4.4.3 Resource Elements

Each element in the resource grid for antenna port p and subcarrier spacing configuration μ is called a resource element and is uniquely identified by (k,l)_{p,μ} where k is the index in the frequency domain and l refers to the symbol position in the time domain relative to some reference point. Resource element (k, l)_{p,μ} corresponds to a physical resource and the complex value α_{k,l}^{(p,μ)}. When there is no risk for confusion, or no particular antenna port or subcarrier spacing is specified, the indices p and μ may be dropped, resulting in α_{k,l}^{(p)} or α_{k,l}.

### 4.4.4 Resource Blocks

### 4.4.4.1 General

A resource block is defined as N_{sc}^{RB}=12 consecutive subcarriers in the frequency domain.

### 4.4.4.2 Point A

Point A serves as a common reference point for resource block grids and is obtained from:
offsetToPointA for a PCell downlink where offsetToPointA represents the frequency offset between point A and the lowest subcarrier of the lowest resource block, which has the subcarrier spacing provided by the higher-layer parameter subCarrierSpacingCommon and overlaps with the SS/PBCH block used by the UE for initial cell selection, expressed in units of resource blocks assuming 15 kHz subcarrier spacing for FR1 and 60 kHz subcarrier spacing for FR2;
absoluteFrequencyPointA for all other cases where absoluteFrequencyPointA represents the frequency-location of point A expressed as in ARFCN.

### 4.4.4.3 Common Resource Blocks

Common resource blocks are numbered from 0 and upwards in the frequency domain for subcarrier spacing configuration pt. The center of subcarrier 0 of common resource block 0 for subcarrier spacing configuration μ coincides with ‘point A’.

The relation between the common resource block number n_{CRB}^{μ} in the frequency domain and resource elements (k,l) for subcarrier spacing configuration μ is given by

$${n}_{C R B}^{μ} = ⌊ \frac{k}{{N}_{s c}^{P B}} ⌋$$

where k is defined relative to point A such that k=0 corresponds to the subcarrier centered around point A.

### 4.4.4.4 Physical Resource Blocks

Physical resource blocks for subcarrier configuration μ are defined within a bandwidth part and numbered from 0 to N_{BWP,i}^{size,μ}−1 where i is the number of the bandwidth part. The relation between the physical resource block n_{PRB}^{μ} in bandwidth part i and the common resource block n_{CRB}^{μ} is given by

n_{CRB}^{μ}=n_{PRB}^{μ}+N_{BWP,i}^{start,μ}

where N_{BWP,i}^{start,μ} is the common resource block where bandwidth part starts relative to common resource block 0. When there is no risk for confusion the index μ may be dropped.

### 4.4.4.5 Virtual Resource Blocks

Virtual resource blocks are defined within a bandwidth part and numbered from 0 to N_{BWP,i}^{size}−1 where i is the number of the bandwidth part.

### 4.4.5 Bandwidth Part

A bandwidth part is a subset of contiguous common resource blocks defined in subclause 4.4.4.3 for a given numerology μᵢ in bandwidth part i on a given carrier. The starting position N_{BWP,i}^{start,μ} and the number of resource blocks N_{BWP,i}^{size,μ} in a bandwidth part shall fulfil N_{grid,x}^{start,μ}≤N_{BWP,i}^{start,μ}<N_{grid,x}^{start,μ}+N_{grid,x}^{size,μ} and N_{grid,x}^{start,μ}<N_{BWP,i}^{start,μ}+N_{BWP,i}^{size,μ}≤N_{grid,x}^{start,μ}+

Configuration of a bandwidth part is described in clause 12 of [5, TS 38.213].

A UE can be configured with up to four bandwidth parts in the downlink with a single downlink bandwidth part being active at a given time. The UE is not expected to receive PDSCH, PDCCH, or CSI-RS (except for RRM) outside an active bandwidth part.

A UE can be configured with up to four bandwidth parts in the uplink with a single uplink bandwidth part being active at a given time. If a UE is configured with a supplementary uplink, the UE can in addition be configured with up to four bandwidth parts in the supplementary uplink with a single supplementary uplink bandwidth part being active at a given time. The UE shall not transmit PUSCH or PUCCH outside an active bandwidth part. For an active cell, the UE shall not transmit SRS outside an active bandwidth part.

Unless otherwise noted, the description in this specification applies to each of the bandwidth parts. When there is no risk of confusion, the index μ may be dropped from N_{BWP,i}^{start,μ}, N_{BWP,i}^{size,μ}, N_{grid,x}^{start,μ}, and N_{grid,x}^{size,μ}.

### 4.5 Carrier Aggregation

Transmissions in multiple cells can be aggregated. Unless otherwise noted, the description in this specification applies to each of the serving cells.

A bandwidth part comprises a frequency location (e.g. a starting position in frequency domain or a starting resource block) and a bandwidth. When a bandwidth part (of a serving cell) is active, the UE performs transmission (for UL bandwidth part) and/or reception (DL bandwidth part) within the frequency resources of the bandwidth part (e.g. determined based on the frequency location and/or bandwidth of the bandwidth part). Bandwidth of a bandwidth part is up to 275 PRBs based on subcarrier spacing of the bandwidth part. Bandwidth part of a UE could be adapted or switched.

For example, a UE could be configured with multiple bandwidth parts. One of the multiple bandwidth parts could be activated or be active (at one time). When a first bandwidth part is active, the UE could activate a second bandwidth part (e.g. and deactivate the second bandwidth part). The bandwidth part adaptation or switch or change could then be achieved. There are several ways to change active bandwidth part, e.g. by Radio Resource Control (RRC), Downlink Control Information (DCI), timer, or random access procedure. 3GPP TS 38.213 and TS 38.331 provide the following details about bandwidth part:

### Bandwidth Part Operation

If the UE is configured with a SCG, the UE shall apply the procedures described in this clause for both MCG and SCG
When the procedures are applied for MCG, the terms ‘secondary cell’, ‘secondary cells’, ‘serving cell’, ‘serving cells’ in this clause refer to secondary cell, secondary cells, serving cell, serving cells belonging to the MCG respectively.
When the procedures are applied for SCG, the terms ‘secondary cell’, ‘secondary cells’, ‘serving cell’, ‘serving cells’ in this clause refer to secondary cell, secondary cells (not including PSCell), serving cell, serving cells belonging to the SCG respectively. The term ‘primary cell’ in this clause refers to the PSCell of the SCG.

A UE configured for operation in bandwidth parts (BWPs) of a serving cell, is configured by higher layers for the serving cell a set of at most four bandwidth parts (BWPs) for receptions by the UE (DL BWP set) in a DL bandwidth by parameter BWP-Downlink or by parameter initialDownlinkBWP with a set of parameters configured by BWP-DownlinkCommon and BWP-DownlinkDedicated, and a set of at most four BWPs for transmissions by the UE (UL BWP set) in an UL bandwidth by parameter BWP-Uplink or by parameter initialUplinkBWP with a set of parameters configured by BWP-UplinkCommon and BWP-UplinkDedicated.

If a UE is not provided initiolDownlinkBWP, an initial DL BWP is defined by a location and number of contiguous PRBs, starting from a PRB with the lowest index and ending at a PRB with the highest index among PRBs of a CORESET for Type0-PDCCH CSS set, and a SCS and a cyclic prefix for PDCCH reception in the CORESET for Type0-PDCCH CSS set; otherwise, the initial DL BWP is provided by initiolDownlinkBWP. For operation on the primary cell or on a secondary cell, a UE is provided an initial UL BWP by initialUplinkBWP. If the UE is configured with a supplementary UL carrier, the UE can be provided an initial UL BWP on the supplementary UL carrier by initialUplinkBWP.

If a UE has dedicated BWP configuration, the UE can be provided by firstActiveDownlinkBWP-Id a first active DL BWP for receptions and by firstActiveUplinkBWP-Id a first active UL BWP for transmissions on a carrier of the primary cell.

For each DL BWP or UL BWP in a set of DL BWPs or UL BWPs, respectively, the UE is provided the following parameters for the serving cell as defined in [4, TS 38.211] or [6, TS 38.214]:
a SCS by subcarrierSpacing
a cyclic prefix by cyclicPrefix
a common RB N_{BWP}^{start}=O_{carrier}+RBₛₜₐᵣₜ and a number of contiguous RBs N_{BWP}^{size}=L_{RB} provided by locationAndBandwidth that indicates an offset RBₛₜₐᵣₜ and a length L_{RB} as RIV according to [6, TS 38.214], setting N_{BWP}^{size}=275, and a value O_{carrier} provided by offsetToCarrier for the subcarrierSpacing
an index in the set of DL BWPs or UL BWPs by respective BWP-Id
a set of BWP-common and a set of BWP-dedicated parameters by BWP-DownlinkCommon and BWP-DownlinkDedicated for the DL BWP, or BWP-UplinkCommon and BWP-UplinkDedicated for the UL BWP [12, TS 38.331]

For unpaired spectrum operation, a DL BWP from the set of configured DL BWPs with index provided by BWP-Id is linked with an UL BWP from the set of configured UL BWPs with index provided by BWP-Id when the DL BWP index and the UL BWP index are same. For unpaired spectrum operation, a UE does not expect to receive a configuration where the center frequency for a DL BWP is different than the center frequency for an UL BWP when the BWP-Id of the DL BWP is same as the BWP-Id of the UL BWP.

For each DL BWP in a set of DL BWPs of the PCell, or of the PUCCH-SCell, a UE can be configured CORESETs for every type of CSS sets and for USS as described in Clause 10.1. The UE does not expect to be configured without a CSS set on the PCell, or on the PUCCH-SCell, of the MCG in the active DL BWP.

If a UE is provided controlResourceSetZero and searchSpaceZero in PDCCH-ConfigSIB1 or PDCCH-ConfigCommon, the UE determines a CORESET for a search space set from controlResourcesetZero as described in Clause 13 and for Tables 13-1 through 13-10, and determines corresponding PDCCH monitoring occasions as described in Clause 13 and for Tables 13-11 through 13-15. If the active DL BWP is not the initial DL BWP, the UE determines PDCCH monitoring occasions for the search space set only if the CORESET bandwidth is within the active DL BWP and the active DL BWP has same SCS configuration and same cyclic prefix as the initial DL BWP.

For each UL BWP in a set of UL BWPs of the PCell or of the PUCCH-SCell, the UE is configured resource sets for PUCCH transmissions as described in Clause 9.2.1.

A UE receives PDCCH and PDSCH in a DL BWP according to a configured SCS and CP length for the DL BWP. A UE transmits PUCCH and PUSCH in an UL BWP according to a configured SCS and CP length for the UL BWP.

If a bandwidth part indicator field is configured in DCI format 1_1 or DCI format 1_2, the bandwidth part indicator field value indicates the active DL BWP, from the configured DL BWP set, for DL receptions as described in [5, TS 38.212]. If a bandwidth part indicator field is configured in DCI format 0_1 or DCI format 0_2, the bandwidth part indicator field value indicates the active UL BWP, from the configured UL BWP set, for UL transmissions as described in [5, TS 38.212]. If a bandwidth part indicator field is configured in a DCI format and indicates an UL BWP or a DL BWP different from the active UL BWP or DL BWP, respectively, the UE shall
for each information field in the DCI format
   if the size of the information field is smaller than the one required for the DCI format interpretation for the UL BWP or DL BWP that is indicated by the bandwidth part indicator, the UE prepends zeros to the information field until its size is the one required for the interpretation of the information field for the UL BWP or DL BWP prior to interpreting the DCI format information fields, respectively
   if the size of the information field is larger than the one required for the DCI format interpretation for the UL BWP or DL BWP that is indicated by the bandwidth part indicator, the UE uses a number of least significant bits of the DCI format equal to the one required for the UL BWP or DL BWP indicated by bandwidth part indicator prior to interpreting the DCI format information fields, respectively
set the active UL BWP or DL BWP to the UL BWP or DL BWP indicated by the bandwidth part indicator in the DCI format

If a bandwidth part indicator field is configured in a DCI format 0_1 and indicates an active UL BWP with different SCS configuration μ, or with different number N_{RB-set,UL}^{BWP} of RB sets, than a current active UL BWP, the UE determines an uplink frequency domain resource allocation Type 2 based on X′ bits and Y′ bits that are generated by independently truncating or padding the X MSBs and the Y LSBs [6, TS 38.214] of the frequency domain resource assignment field of DCI format 0_1, where truncation starts from the MSBs of the X bits or the Y bits, zero-padding prepends zeros to the X bits or the Y bits, and
if the indicated active UL BWP has SCS configuration μ=1 and the current active BWP has SCS configuration μ=0, the X MSBs are truncated to X′=X−1 bits, or
if the indicated active UL BWP has SCS configuration μ=0 and the current active BWP has SCS configuration μ=1, the X MSBs are zero-padded to X′=X+1 bits
otherwise, the X MSBs are unchanged
   and

$${Y}^{′} = ⌈ {log}_{2} ( \frac{{N}_{R B - set , UL}^{B W P} ( {N}_{R B - set , UL}^{B W P} + 1 )}{2} ) ⌉ bits$$

the Y LSBs are truncated or zero-padded to
where N_{RB-set,UL}^{BWP} is a number of RB sets configured for the indicated active UL BWP

A UE does not expect to detect a DCI format indicating an active DL BWP or an active UL BWP change with the corresponding time domain resource assignment field providing a slot offset value for a PDSCH reception or PUSCH transmission that is smaller than a delay required by the UE for an active DL BWP change or UL BWP change, respectively [10, TS 38.133].

If a UE detects a DCI format indicating an active DL BWP change for a cell, the UE is not required to receive or transmit in the cell during a time duration from the end of the third symbol of a slot where the UE receives the PDCCH that includes the DCI format in a scheduling cell until the beginning of a slot indicated by the slot offset value of the time domain resource assignment field in the DCI format.

If a UE detects a DCI format indicating an active UL BWP change for a cell, the UE is not required to receive or transmit in the cell during a time duration from the end of the third symbol of a slot where the UE receives the PDCCH that includes the DCI format in the scheduling cell until the beginning of a slot indicated by the slot offset value of the time domain resource assignment field in the DCI format.

A UE does not expect to detect a DCI format indicating an active DL BWP change or an active UL BWP change for a scheduled cell within FR1 (or FR2) in a slot other than the first slot of a set of slots for the DL SCS of the scheduling cell that overlaps with a time duration where the UE is not required to receive or transmit, respectively, for an active BWP change in a different cell from the scheduled cell within FR1 (or FR2).

A UE expects to detect a DCI format indicating an active UL BWP change or an active DL BWP change only if a corresponding PDCCH is received within the first 3 symbols of a slot.

For a serving cell, a UE can be provided by defaultDownlinkBWP-Id a default DL BWP among the configured DL BWPs. If a UE is not provided a default DL BWP by defaultDownlinkBWP-Id, the default DL BWP is the initial DL BWP.

If a UE is provided by bwp-InactivityTimer a timer value for the serving cell [11, TS 38.321] and the timer is running, the UE decrements the timer at the end of a subframe for FR1 or at the end of a half subframe for FR2 if the restarting conditions in [11, TS 38.321] are not met during the interval of the subframe for FR1 or of the half subframe for FR2.

For a cell where a UE changes an active DL BWP due to a BWP inactivity timer expiration and for accommodating a delay in the active DL BWP change or the active UL BWP change required by the UE [10, TS 38.133], the UE is not required to receive or transmit in the cell during a time duration from the beginning of a subframe for FR1, or of half of a subframe for FR2, that is immediately after the BWP inactivity timer expires until the beginning of a slot where the UE can receive or transmit.

When a UE's BWP inactivity timer for a cell within FR1 (or FR2) expires within a time duration where the UE is not required to receive or transmit for an active UL/DL BWP change in the cell or in a different cell within FR1 (or FR2), the UE delays the active UL/DL BWP change triggered by the BWP inactivity timer expiration until a subframe for FR1 or half a subframe for FR2 that is immediately after the UE completes the active UL/DL BWP change in the cell or in the different cell within FR1 (or FR2).

If a UE is provided by firstActiveDownlinkBWP-Id a first active DL BWP and by firstActiveUplinkBWP-Id a first active UL BWP on a carrier of a secondary cell, the UE uses the indicated DL BWP and the indicated UL BWP as the respective first active DL BWP on the secondary cell and first active UL BWP on the carrier of the secondary cell.

A UE does not expect to monitor PDCCH when the UE performs RRM measurements [10, TS 38.133] over a bandwidth that is not within the active DL BWP for the UE.

[. . . ]

### BWP

The IE BWP is used to configure generic parameters of a bandwidth part as defined in TS 38.211 [16], clause 4.5, and TS 38.213 [13], clause 12.

For each serving cell the network configures at least an initial downlink bandwidth part and one (if the serving cell is configured with an uplink) or two (if using supplementary uplink (SUL)) initial uplink bandwidth parts. Furthermore, the network may configure additional uplink and downlink bandwidth parts for a serving cell.

The uplink and downlink bandwidth part configurations are divided into common and dedicated parameters.

BWP information element

| | |
|---|---|
| -- ASN1START | |
| -- TAG-BWP-START | |
| BWP ::= | SEQUENCE { |
| locationAndBandwidth | INTEGER (0..37949), |
| subcarrierSpacing | SubcarrierSpacing, |
| cyclicPrefix | ENUMERATED { extended } |
| OPTIONAL -- Need R | |
| } | |
| -- TAG-BWP-STOP | |
| -- ASN1STOP | |

BWP field descriptions

cyclicPrefix
Indicates whether to use the extended cyclic prefix for this bandwidth part. If not set, the UE uses
the normal cyclic prefix. Normal CP is supported for all subcarrier spacings and slot formats.
Extended CP is supported only for 60 kHz subcarrier spacing. (see TS 38.211 [16], clause 4.2)
locationAndBandwidth
Frequency domain location and bandwidth of this bandwidth part. The value of the field shall be
interpreted as resource indicator value (RIV) as defined TS 38.214 [19] with assumptions as
described in TS 38.213 [13], clause 12, i.e. setting N^{size}_{BWP} = 275. The first PRB is a PRB determined
by subcarrierSpacing of this BWP and offsetToCarrier (configured in SCS-SpecificCarrier contained
within FrequencyInfoDL/FrequencyInfoUL/FrequencyInfoUL-SIB/FrequencyInfoDL-SIB within
ServingCellConfigCommon/ServingCellConfigCommonSIB) corresponding to this subcarrier
spacing. In case of TDD, a BWP-pair (UL BWP and DL BWP with the same bwp-Id) must have the
same center frequency (see TS 38.213 [13], clause 12)
subcarrierSpacing
Subcarrier spacing to be used in this BWP for all channels and reference signals unless explicitly
configured elsewhere. Corresponds to subcarrier spacing according to TS 38.211 [16], table 4.2-1.
The value kHz 15 corresponds to μ = 0, value kHz 30 corresponds to μ = 1, and so on. Only the
values 15 kHz, 30 kHz, or 60 kHz (FR1), and 60 kHz or 120 kHz (FR2) are applicable. For the
initial DL BWP this field has the same value as the field subCarrierSpacingCommon in MIB of
the same serving cell.

[. . . ]

### SCS-SpecificCarrier

The IE SCS-SpecificCarrier provides parameters determining the location and width of the actual carrier or the carrier bandwidth. It is defined specifically for a numerology (subcarrier spacing (SCS)) and in relation (frequency offset) to Point A.

SCS-SpecificCarrier information element

-- ASN1START

-- TAG-SCS-SPECIFICCARRIER-START

| | |
|---|---|
| SCS-SpecificCarrier ::= | SEQUENCE { |
| offsetToCarrier | INTEGER (0..2199), |
| subcarrierSpacing | SubcarrierSpacing, |
| carrierBandwidth | INTEGER |
| | (1..maxNrofPhysicalResourceBlocks), |
| ..., | |
| [ [ | |
| txDirectCurrentLocation | INTEGER (0..4095) |
| OPTIONAL -- Need S | |
| ] ] | |
| } | |

-- TAG-SCS-SPECIFICCARRIER-STOP
-- ASN1STOP

SCS-SpecificCarrier field descriptions

carrierBandwidth
Width of this carrier in number of PRBs (using the subcarrierSpacing defined for this carrier) (see
TS 38.211 [16], clause 4.4.2).
offsetToCarrier
Offset in frequency domain between Point A (lowest subcarrier of common RB 0) and the lowest
usable subcarrier on this carrier in number of PRBs (using the subcarrierSpacing defined for this
carrier). The maximum value corresponds to 275 * 8 − 1. See TS 38.211 [16], clause 4.4.2.
txDirectCurrentLocation
Indicates the downlink Tx Direct Current location for the carrier. A value in the range 0 . . . 3299
indicates the subcarrier index within the carrier. The values in the value range 3301 . . . 4095 are
reserved and ignored by the UE. If this field is absent for downlink within
ServingCellConfigCommon and ServingCellConfigCommonSIB, the UE assumes the default value
of 3300 (i.e. “Outside the carrier”). (see TS 38.211 [16], clause 4.4.2). Network does not configure
this field via ServingCellConfig or for uplink carriers.
subcarrierSpacing
Subcarrier spacing of this carrier. It is used to convert the offsetToCarrier into an actual frequency.
Only the values 15 kHz, 30 kHz or 60 kHz (FR1), and 60 kHz or 120 kHz (FR2) are applicable.

Resource allocation in frequency domain for data channel, e.g. Physical Downlink Shared Channel (PDSCH) or Physical Uplink Shared Channel (PUSCH), is done via an information filed carried on downlink control information (DCI). DCI can be carried on a Physical Downlink Control Channel (PDCCH) scheduling the data channel. A bit map or a resource indicator value (RIV) can be used to indicate resource(s) within a bandwidth of a bandwidth portion. A bit map can comprise a plurality of bits and indicate resource allocated for a UE, e.g. each bit could be associated with one resource unit, e.g. one physical resource block (PRB) or one RBG (resource block group), and e.g. a bit with value “1” indicates an associated resource unit is allocated for the UE. For example, “1001 . . . ” means first and fourth resource units are allocated to the UE while second and third resource units are not allocated to the UE.

A Resource Indicator Value (RIV) would indicate a set of contiguous resources allocated for the UE. A UE can derive from the RIV a starting position and a length (e.g. in a unit of resource unit) of the allocated resource. For example, if the staring position is 3 and length is 5, the resources allocated to the UE are resource unit 3-7. 3GPP TS 38.214 provides the following details about resource allocation:

### 5.1.2.2 Resource Allocation in Frequency Domain

Two downlink resource allocation schemes, type 0 and type 1, are supported. The UE shall assume that when the scheduling grant is received with DCI format 1_0, then downlink resource allocation type 1 is used.

If the scheduling DCI is configured to indicate the downlink resource allocation type as part of the Frequency domain resource assignment field by setting a higher layer parameter resourceAllocation in pdsch-Config to ‘dynamicswitch’, for DCI format 1_1 or setting a higher layer parameter resourceAllocation-ForDCIFormat1_2 in pdsch-Config to ‘dynamicswitch’ for DCI format 1_2, the UE shall use downlink resource allocation type 0 or type 1 as defined by this DCI field. Otherwise the UE shall use the downlink frequency resource allocation type as defined by the higher layer parameter resourceAllocation for DCI format 1_1 or by the higher layer parameter resourceAllocation-ForDCIFormat1_2 for DCI format 1_2.

If a bandwidth part indicator field is not configured in the scheduling DCI or the UE does not support active BWP change via DCI, the RB indexing for downlink type 0 and type 1 resource allocation is determined within the UE's active bandwidth part. If a bandwidth part indicator field is configured in the scheduling DCI and the UE supports active BWP change via DCI, the RB indexing for downlink type 0 and type 1 resource allocation is determined within the UE's bandwidth part indicated by bandwidth part indicator field value in the DCI. The UE shall upon detection of PDCCH intended for the UE determine first the downlink bandwidth part and then the resource allocation within the bandwidth part.

For a PDSCH scheduled with a DCI format 1_0 in any type of PDCCH common search space, regardless of which bandwidth part is the active bandwidth part, RB numbering starts from the lowest RB of the CORESET in which the DCI was received; otherwise RB numbering starts from the lowest RB in the determined downlink bandwidth part.

### 5.1.2.2.1 Downlink Resource Allocation Type 0

In downlink resource allocation of type 0, the resource block assignment information includes a bitmap indicating the Resource Block Groups (RBGs) that are allocated to the scheduled UE where a RBG is a set of consecutive virtual resource blocks defined by higher layer parameter rbg-Size configured by PDSCH-Config and the size of the bandwidth part as defined in Table 5.1.2.2.1-1.

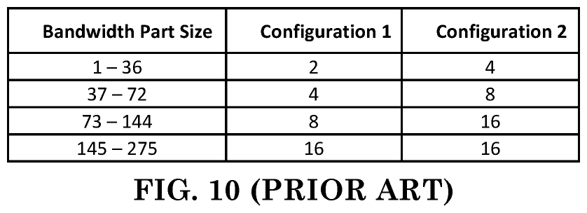

### [Table 5.1.2.2.1-1 of 3GPP TS 38.214 V16.2.0, Entitled “Nominal RBG Size P”, is Reproduced as FIG. 10]

The total number of RBGs (N_{RBG}) for a downlink bandwidth part i of size N_{BWP}^{size} is given by

N_{RBG}=┌(N_{BWP,i}^{size}+(N_{BWP,i}^{start}modP))/P┐,

where
the size of the first RBG is RBG₀^{size}=P−N_{BWP,i}^{start}modP,
the size of last RBG is RBGₗₐₛₜ^{size}=(N_{BWP,i}^{start}+N_{BWP,i}^{size})modP if (N_{BWP,i}^{start}+N_{BWP,i}^{size})modP>0 and P otherwise,
the size of all other RBGs is P.

The bitmap is of size N_{RBG} bits with one bitmap bit per RBG such that each RBG is addressable. The RBGs shall be indexed in the order of increasing frequency and starting at the lowest frequency of the bandwidth part. The order of RBG bitmap is such that RBG 0 to RBG_{N}_{_{RBG}}₋₁ are mapped from MSB to LSB. The RBG is allocated to the UE if the corresponding bit value in the bitmap is 1, the RBG is not allocated to the UE otherwise.

### 5.1.2.2.2 Downlink Resource Allocation Type 1

In downlink resource allocation of type 1, the resource block assignment information indicates to a scheduled UE a set of contiguously allocated non-interleaved or interleaved virtual resource blocks within the active bandwidth part of size N _{BWP}^{size} PRBs except for the case when DCI format 1_0 is decoded in any common search space in which case the size of CORESET 0 shall be used if CORESET 0 is configured for the cell and the size of initial DL bandwidth part shall be used if CORESET 0 is not configured for the cell.

A downlink type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by

if(L_{RBS}−1)≤└N_{BWP}^{size}/2┘ then

RIB=N_{BWP}^{size}(L_{RBs}−1)+RBₛₜₐᵣₜ

else

RIV=N_{BWP}^{size}(N_{BWP}^{size}−L_{RBs}+1)+(N_{BWP}^{size}−1−RBₛₜₐᵣₜ)

where L_{RBs}≥1 and shall not exceed N_{BWP}^{size}−RBₛₜₐᵣₜ.

When the DCI size for DCI format 1_0 in USS is derived from the size of DCI format 1_0 in CSS but applied to an active BWP with size of N _{BWP}^{active}, a downlink type 1 resource block assignment field consists of a resource indication value (RIV) corresponding to a starting resource block RBₛₜₐᵣₜ=0, K,2·K, . . . , (N_{BWP}^{initial}−1)·K and a length in terms of virtually contiguously allocated resource blocks L_{RBs}=K,2·K, . . . , N_{BWP}^{initial}·K, where N_{BWP}^{initial} is given by
the size of CORESET 0 if CORESET 0 is configured for the cell;
the size of initial DL bandwidth part if CORESET 0 is not configured for the cell.

The resource indication value is defined by:

if (L′_{RBs}−1)≤└N_{BWP}^{initial}/2┘ then

RIV=N_{BWP}^{initial}(L′_{RBs}−1)+RB′ₛₜₐᵣₜ

else

RIV=N_{BWP}^{initial}(N_{BWP}^{initial}−L′_{RBs}+1+(N_{BWP}^{initial}−1−RB′ₛₜₐᵣₜ)

where L′_{RBs}=L_{RBs}/K, RB′ₛₜₐᵣₜ=RBₛₜₐᵣₜ/K and where L′_{RBs} shall not exceed N_{BWP}^{initial}−RB′ₛₜₐᵣₜ.

If N_{BWP}^{active}>N_{BWP}^{initial}, K is the maximum value from set {1, 2, 4, 8} which satisfies K≤└N_{BWP}^{active}/N_{BWP}^{initial}┘; otherwise K=1.

When the scheduling grant is received with DCI format 1_2, a downlink type 1 resource allocation field consists of a resource indication value (RIV) corresponding to a starting resource block group RBGₛₜₐᵣₜ=0, 1, . . ., N_{RBG}−1 and a length in terms of virtually contiguously allocated resource block groups L_{RBGs}=1, . . . , N_{RBG}, where the resource block groups are defined as in 5.1.2.2.1 with P defined by ResourceAllocationType1-granularity-ForDCIFormat1_2 if the UE is configured with higher layer parameter ResourceAllocationType1-granularity-ForDCIFormat1_2, and P=1 otherwise. The resource indication value is defined by

if(L_{RBGs}−1)≤└N_{RBG}/2┘ then

RIB=N_{RBG}(L_{RBGs}−1)+RBGₛₜₐᵣₜ

else

RIV=N_{RBG}(N_{RBG}−L_{RBGs}+1)+(N_{RBG}−1−RBGₛₜₐᵣₜ)

where L_{RBGs}≥1 and shall not exceed N_{RBG}−RBGₛₜₐᵣₜ.

There is a study of operation in frequency band higher than 52.6 GHz. Some amendments are under consideration as there are several different characteristics which is different from the lower conventional frequency band, e.g. wider available bandwidth, larger (phase) noise, or inter carrier interference (ICI). Therefore, it is expected that a larger subcarrier spacing, e.g. up to 960 kHz, and a bandwidth of a cell would be increased to GHz level, e.g. 1 or 2 GHz. In particular, 3GPP RP-193259 states:

This study item will include the following objectives:,
Study of required changes to NR using existing DL/UL NR waveform to support operation between 52.6 GHz and 71 GHz
   Study of applicable numerology including subcarrier spacing, channel BW (including maximum BW), and their impact to FR2 physical layer design to support system functionality considering practical RF impairments [RAN1, RAN4].
   Identify potential critical problems to physical signal/channels, if any [RAN1].

As discussed above, resource allocation for a UE is confined within bandwidth of a Bandwidth Part (BWP), e.g. active BWP of the UE and the resource can be allocated to a UE is up to bandwidth of the BWP, e.g. N Physical Resource Blocks (PRBs). To support a larger bandwidth of a cell, a larger subcarrier spacing is preferred, e.g. 960 kHz. With existing Fast Fourier Transform (FFT)/Inverse Fourier Transform (IFFT) size, e.g. up to a size of 4096, the number of PRBs UE is able to received is confined (as # of PRB*12 should be smaller than FFT/IFFT size). For example, the number of PRBs (for a bandwidth part/cell) is confined to 275. For 960 kHz subcarrier spacing, 275 PRBs corresponds to about 3.2 GHz bandwidth. In other words, when a UE operates with a (active) bandwidth part with 960 kHz subcarrier spacing, the UE could be scheduled with resource within 3.2 GHz bandwidth. In this case both RF and base band of the UE would operate with 3.2 GHz bandwidth (or slightly larger or smaller considering guard band). On the other hand, when the UE operates with a (active) bandwidth part with 240 kHz subcarrier spacing, the schedulable bandwidth would be reduced to resource within 0.8 GHz, even if 3.2 GHz bandwidth is supported by the UE. In other words, the candidate resources are reduced if the subcarrier spacing is reduced. The difference would become more significant if the difference between the subcarrier spacing of the bandwidth part is smaller. The scheduling efficiency would be reduced as well considering such constraint of smaller bandwidth.

A first general concept of this invention is to decouple bandwidth of a bandwidth part and the maximum number of bandwidth or resources that could be scheduled to the UE within the bandwidth part. A first bandwidth could be used as bandwidth of a bandwidth part and a second bandwidth is used as maximum bandwidth that could be scheduled to the UE within the bandwidth part. In other words, when a bandwidth part with X PRBs is active, a maximum number of PRBs that can be allocated to the UE is Y PRB. When a bandwidth part with X PRBs is active, a maximum bandwidth that can be allocated to the UE is Y PRB. A bandwidth that can be allocated to a UE could be derived from a difference between a PRB with smallest index allocated to the UE and a PRB with largest index allocated to the UE. A difference between a PRB with smallest index allocated to the UE and a PRB with largest index allocated to the UE is smaller than Y. Y could be different from X. Y could be smaller than X. X PRBs and Y PRBs could be based on subcarrier spacing of the bandwidth part. X could be larger than 275. Y may not be larger than 275.

One way to achieve the first general concept could be to restrict the base station scheduling. Resource allocation field in the DCI can signal or indicate resource up to a bandwidth of X PRBs while base station can only schedule resource up to a bandwidth of Y PRBs. The base station may not be allowed to schedule resource with a bandwidth of more than Y PRBs.

Another way to achieve the first general concept could be to develop a new way to allocate resource. The new way can allocate resources (e.g. candidate resources) over a bandwidth of X PRBs, while the resource indicated to the UE may not exceed Y PRBs. For example, the DCI could indicate frequency position (and/or size) of a window within a bandwidth part. The frequency position could be a first PRB of the window (within the bandwidth part). The frequency position could be a center PRB of the window (within the bandwidth part). The frequency position could be a specific PRB of the window (within the bandwidth part). The bandwidth part may have a bandwidth of X PRBs. The window may have a bandwidth of Y PRBs. The DCI could indicate resource allocation within the window. Resource allocation within the window could be done via a bit map. Resource allocation within the window could be done via a RIV value.

Bit-width/size of the bitmap could be determined based on Y PRBs. Bit-width/size of the bitmap could be determined based on size of the window. Bit-width/size of the bitmap may not be determined based on X PRBs. Bit-width/size of the bitmap may not be determined based on size of the bandwidth part.

Bit-width/size of the RIV value may not be determined based on Y PRBs. Bit-width/size of the RIV value could be determined based on size of the window. Bit-width/size of the RIV value may not be determined based on X PRBs. Bit-width/size of the RIV value may not be determined based on size of the bandwidth part. The frequency position can be indicated by a field with bit-width/size of log₂|X−Y|. A field of 00 . . . 00 (all 0's) could indicate the window start from the first PRB of the bandwidth part. The window could occupy 1^{st}˜Yth PRB of the bandwidth part. Resource allocation could be done within 1^{st}˜Yth PRB of the bandwidth part (when the field for frequency position is all 0's).

A field of 00 . . . 01 could indicate the window start from the second PRB of the bandwidth part. The window could occupy 2^{nd}˜(Y+1)th PRB of the bandwidth part. Resource allocation could be done within 2^{nd}˜(Y+1)th PRB of the bandwidth part (when the field for frequency position is 00 . . . 01).

The frequency position can be indicated by a field with bit-width/ size of log₂x/y (note that a nearby integer could be chosen if X/Y is not an integer, e.g. via ceiling operation or floor operation). A field of 00 . . . 00 (all 0's) could indicate the window start from the first PRB of the bandwidth part. The window could occupy 1^{st}˜Yth PRB of the bandwidth part. Resource allocation could be done within 1^{st}˜Yth PRB of the bandwidth part (when the field for frequency position is all 0's).

A field of 00 . . . 01 could indicate the window start from the (Y+1)th PRB of the bandwidth part. The window could occupy (Y+1)th˜2Yth PRB of the bandwidth part. Resource allocation could be done within (Y+1)th˜2Yth PRB of the bandwidth part (when the field for frequency position is 00 . . . 01).

Allocating resource within the window can be done by replacing starting PRB of a bandwidth part with starting PRB of a window and/or replacing bandwidth of a bandwidth part with bandwidth of a window. For example, the total number of RBGs (N_{RBG}) for a window of size Y within downlink bandwidth part i is given by N_{RBG}=┌(Y+(N_{Window}^{Start}ModP))_{/p}┐ where
the size of the first RBG is RBG₀^{size}=P−N_{Window}^{start}.
the size of last RBG is RBGₗₐₛₜ^{size}=(N_{window}^{start}+Y)mod P if (N_{window}^{start}+Y)mod P>0 and P otherwise,
the size of all other RBGs is P.

The bitmap could be of size N_{RBG}bits with one bitmap bit per Resource Block Group (RBG) such that each RBG could be addressable. The RBGs could be indexed in the order of increasing frequency and starting at the lowest frequency of the widow. The lowest frequency of the widow could be indicated by a Downlink Control Information (DCI), e.g. relative to the lowest frequency of the bandwidth part. The order of RBG bitmap is such that RBG 0 to RBG_{N}_{_{RBG}}−1 are mapped from Most Significant Bit (MSB) to Least Significant Bit (LSB). The RBG could be allocated to the UE if the corresponding bit value in the bitmap is 1, the RBG may not be allocated to the UE otherwise.

In another example, a downlink type 1 resource allocation field consists of a resource indication value (RIV) corresponding to a starting virtual resource block (RBₛₜₐᵣₜ^{window}+RBₛₜₐᵣₜ) and a length in terms of contiguously allocated resource blocks L_{RBS}·RBₛₜₐᵣₜ^{window} is the lowest frequency of a window of size Y (e.g. indicated by a DCI relative to the lowest frequency of the bandwidth part). The resource indication value is defined by

if (L_{RBS}−1)≤└N_{BWP}^{size}/2┘(L_{RBs}−1)≤└Y/2┘ then

RIV=Y(L_{RBs}−1)+RBₛₜₐᵣₜ

else

RIV=Y(Y−L_{RBs}+1)+(Y−1−RBₛₜₐᵣₜ)

where L_{RBs}≥1 and shall not exceed Y−RBₛₜₐᵣₜ.

A second general concept of this invention is that a bandwidth of bandwidth part is extended. A bandwidth of a bandwidth part can be extended to more than 275 PRBs. A bandwidth of a bandwidth part could be extended by interpret its location and bandwidth by a reference subcarrier spacing. The reference subcarrier spacing could be different from a subcarrier spacing of the bandwidth part. The reference subcarrier pacing could be larger than a subcarrier spacing of the bandwidth part. The reference subcarrier spacing could be used to interpret frequency location and/or bandwidth of the bandwidth part. For example, using a reference subcarrier spacing of 960 kHz could be used to interpret a frequency location and/or bandwidth of a bandwidth part with 120 kHz can indicate resource across 275*8 PRB (in 120 kHz) for the bandwidth part. The reference subcarrier spacing could be indicated by the base station.

For example, when a reference subcarrier spacing for a 120 KHz bandwidth part is 960 kHz, a “ locationAndBandwidth” field for the bandwidth part could be interpreted by 960 kHz (rather than 120 kHz). The locationAndBandwidth field could point to a first PRB (in 960 kHz) and a number of PRBs (e.g. X PRBs in 960 kHz) for the bandwidth part. After the frequency location and bandwidth is derived, the PRB could then be translated to 120 kHz. The number of PRB in 120 kHz could be X*8. The number of bandwidth could exceed 275. The first PRB in 120 kHz of the bandwidth part could be a PRB (in 120 kHz) which is closest (e.g. in frequency domain with starting position) to the first PRB (in 960 kHz) pointed by the locationAndBandwidth field.

A bandwidth of a bandwidth part could be extended by adding more bit for the locationAndBandwidth field for the bandwidth part. A baseband of UE could operate at a smaller bandwidth of Radio Frequency (RF). RF could cover a bandwidth of bandwidth part. Baseband (e.g. IFFT/FFT) could cover a subset of resource within the bandwidth part. For example, a RF of UE could cover a bandwidth of 3.2 GHz, and baseband of the UE could cover a bandwidth 0.8 GHz.

Throughout the application “window” can be replaced with “a set of frequency resource” or “a set of PRBs”. A window may occupy a subset of frequency resource within a bandwidth part.

In one embodiment, a UE could receive a configuration of a bandwidth part from a base station. The UE could receive an indication of a subset of frequency resources within the bandwidth part. The UE could derive a resource allocation within the subset of resource. The resource allocation could be for a data channel received or transmitted by the UE. The UE may not be allowed to be scheduled outside the subset of frequency resources. The UE may not be allowed to be scheduled one PRB which is outside the subset of frequency resources within the bandwidth part.

The subset of frequency resources could be a set of contiguous frequency resources. The subset of resource could be a window. The subset of frequency resources may comprise a set of contiguous physical resource blocks. Frequency location of the subset of frequency resource could be indicated to the UE. Frequency location of the subset of frequency resource could be indicated by DCI. A first PRB of the subset of frequency resource could be indicated to the UE. A first PRB of the subset of frequency resource could be indicated by a DCI. Bandwidth of the subset of frequency resource could be fixed or pre-defined. Bandwidth of the subset of frequency resource could be indicated to the UE. Bandwidth of the subset of frequency resource could be indicated by a RRC configuration. Bandwidth of the subset of frequency resource could be indicated by a DCI.

The subset of frequency resources may have a smaller bandwidth than a bandwidth of the bandwidth part. The bandwidth part may be an active bandwidth part. The subset of frequency resource could be indicated by a DCI. The DCI could schedule resource for the UE. The DCI could indicate resource allocation within the subset of frequency resources. A bitmap in the DCI could indicate resource allocation within the subset of frequency resources. Bit-width or size of the bitmap could be determined based on the bandwidth of the subset of frequency resources.

A RIV value in the DCI could indicate resource allocation within the subset of frequency resources. Bit-width or size of the RIV value could be determined based on the bandwidth of the subset of frequency resources. Frequency location of the subset of frequency resources and resource allocation within the subset of frequency resources could be indicated by two separate fields in DCI. Frequency location of the subset of frequency resources and resource allocation within the subset of frequency resources could be indicated by two separate set of bits(s) (e.g. in one field) in DCI.

In another embodiment, a base station could transmit a configuration of a bandwidth part to a UE. The base station could transmit an indication of a subset of frequency resources within the bandwidth part. The base station could derive or schedule a resource allocation within the subset of resource. The resource allocation could be for a data channel received or transmitted by the UE. The base station may not be allowed to schedule the UE outside the subset of frequency resources. The base station may not be allowed to schedule the UE a PRB which is outside the subset of frequency resources within the bandwidth part.

The subset of frequency resources could be a set of contiguous frequency resources. The subset of resource could be a window. The subset of frequency resources may comprise a set of contiguous physical resource blocks. Frequency location of the subset of frequency resource could be indicated to the UE. Frequency location of the subset of frequency resource could be indicated by DCI. A first PRB of the subset of frequency resource could be indicated to the UE. A first PRB of the subset of frequency resource is indicated by a DCI. Bandwidth of the subset of frequency resource could be fixed or pre-defined. Bandwidth of the subset of frequency resource could be indicated to the UE. Bandwidth of the subset of frequency resource could be indicated by a RRC configuration. Bandwidth of the subset of frequency resource could be indicated by a DCI.

The subset of frequency resources may have a smaller bandwidth than a bandwidth of the bandwidth part. The bandwidth part could be an active bandwidth part. The subset of frequency resource could be indicated by a DCI. The DCI could schedule resource for the UE. The DCI could indicate resource allocation within the subset of frequency resources. A bitmap in the DCI could indicate resource allocation within the subset of frequency resources. Bit-width or size of the bitmap could be determined based on the bandwidth of the subset of frequency resources. A RIV value in the DCI could indicate resource allocation within the subset of frequency resources.

Bit-width or size of the RIV value could be determined based on the bandwidth of the subset of frequency resources. Frequency location of the subset of frequency resources and resource allocation within the subset of frequency resources could be indicated by two separate fields in DCI. Frequency location of the subset of frequency resources and resource allocation within the subset of frequency resources could be indicated by two separate set of bits(s) (e.g. in one field) in DCI.

In another embodiment, a base station could transmit a configuration of a bandwidth part to a UE. The base station could derive or schedule a resource allocation within the bandwidth part. The resource allocation could be for a data channel received or transmitted by the UE. The base station may not be allowed to be schedule the UE with a resource whose bandwidth is more than Z (PRBs). The bandwidth part could have a bandwidth larger than Z. Bandwidth of the resource could be derived a bandwidth between a PRB of the resource with a lowest PRB index and a PRB of the resource with a highest PRB index. Z could be a fixed or predetermined value. Z could be a configured value. Z could be determined based on a capability of the UE. Z could be 275. A bitmap in the DCI could indicate resource allocation within the bandwidth part subject to above restriction. Bit-width or size of the bitmap could be determined based on the bandwidth of the bandwidth part. A RIV value in the DCI could indicate resource allocation within the bandwidth part subject to above change. Bit-width or size of the RIV value could be determined based on the bandwidth of the bandwidth part.

Throughout the invention, the invention could describe behavior or operation of a single serving cell unless otherwise noted. The invention could also describe behavior or operation of multiple serving cells unless otherwise noted. Furthermore, the invention could describe behavior or operation of a single bandwidth part unless otherwise noted.

Throughout the invention, a base station could configure multiple bandwidth parts to the UE unless otherwise noted. A base station could also configure a single bandwidth part to the UE unless otherwise noted.

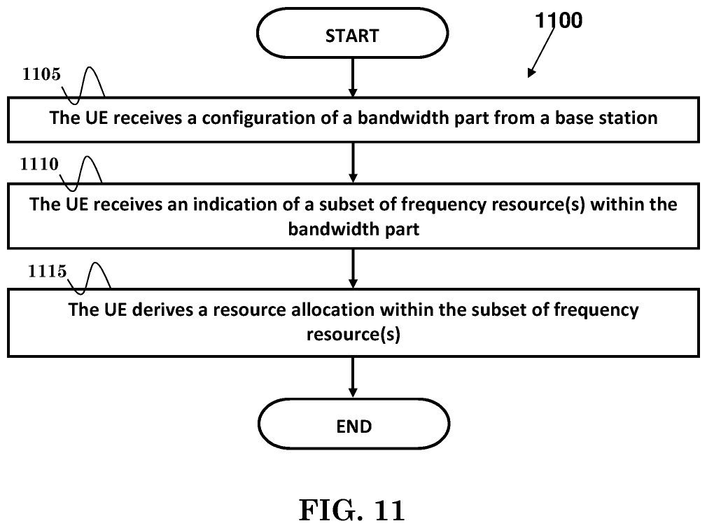

FIG. 11 is a flow chart 1100 according to one exemplary embodiment from the perspective of a UE. In step 1105, the UE receives a configuration of a bandwidth part from a base station. In step 1110, the UE receives an indication of a subset of frequency resource(s) within the bandwidth part. In step 1115, the UE derives a resource allocation within the subset of frequency resource(s).

Referring back to FIGS. 3 and 4, in one exemplary embodiment of a UE. The UE 300 includes a program code 312 stored in the memory 310. The CPU 308 could execute program code 312 to enable the UE (i) to receive a configuration of a bandwidth part from a base station, (ii) to receive an indication of a subset of frequency resource(s) within the bandwidth part, and (iii) to derive a resource allocation within the subset of frequency resource(s). Furthermore, the CPU 308 can execute the program code 312 to perform all of the above-described actions and steps or others described herein.

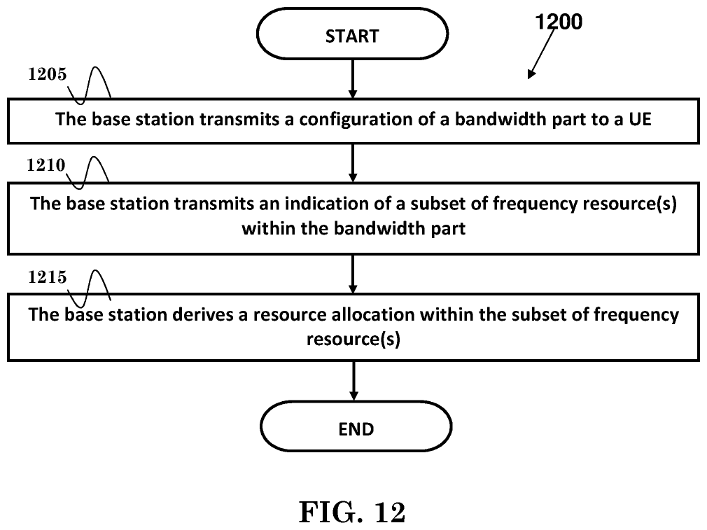

FIG. 12 is a flow chart 1200 according to one exemplary embodiment from the perspective of a base station. In step 1205, the base station transmits a configuration of a bandwidth part to a UE. In step 1210, the base station transmits an indication of a subset of frequency resource(s) within the bandwidth part. In step 1215, the base station derives a resource allocation within the subset of frequency resource(s).

Referring back to FIGS. 3 and 4, in one exemplary embodiment of a base station. The base station 300 includes a program code 312 stored in the memory 310. The CPU 308 could execute program code 312 to enable the base station (i) to transmit a configuration of a bandwidth part to a UE, (ii) to transmit an indication of a subset of frequency resource(s) within the bandwidth part, and (iii) to derive a resource allocation within the subset of frequency resource(s). Furthermore, the CPU 308 can execute the program code 312 to perform all of the above-described actions and steps or others described herein.

In the context of the embodiments illustrated in FIGS. 11 and 12 and discussed above, in one embodiment, the resource allocation could be for for a data channel received or transmitted by the UE. The subset of frequency resource(s) could be a set of contiguous frequency resources.

In one embodiment, the frequency location of the subset of frequency resource(s) could be indicated to the UE. The subset of frequency resource(s) could also be indicated by DCI. The first PRB of the subset of frequency resource(s) could be indicated to the UE. The bandwidth of the subset of frequency resource(s) could be fixed or pre-defined. The bandwidth of the subset of frequency resource(s) could be indicated to the UE. The bandwidth of the subset of frequency resource(s) could be indicated by a Radio Resource Control (RRC) configuration.

In one embodiment, the subset of frequency resource(s) may have a smaller bandwidth than a bandwidth of the bandwidth part. The bandwidth part may be an active bandwidth part. The subset of frequency resource(s) could be indicated by a DCI.

In one embodiment, the DCI could schedule resource for the UE. The DCI could indicate resource allocation within the subset of frequency resources. A bitmap in the DCI could indicate resource allocation within the subset of frequency resource(s).

In one embodiment, bit-width or size of the bitmap could be determined based on the bandwidth of the subset of frequency resource(s). A RIV value in the DCI could indicate resource allocation within the subset of frequency resources. Bit-width or size of the RIV value could be determined based on the bandwidth of the subset of frequency resource(s).

As discussed above, bandwidth part start at a resource block relative to a frequent location, e.g. Point A. There may be slightly different starting location(s) or position(s) of Common Resource Blocks (CRB) for different numerology. Point A could be considered as a reference starting location or position of a carrier, shared by all bandwidth part irrespective of their subcarrier spacing. Irrespective of a subcarrier spacing, the frequency resource can be allocated to a bandwidth part is CRB 0˜CRB 274 (e.g. defined on a per subcarrier spacing basis). In other words, bandwidth parts with different subcarrier spacing could not split into different frequency resources of a carrier.

Taking a carrier or cell with 3.2 GHz as an example, for a bandwidth part with 960 kHz subcarrier spacing, CRB 0˜CRB 274 cover the 3.2 GHz, a whole carrier bandwidth. On the other hand, for a bandwidth part with 120 kHz, CRB 0˜CRB 274 cover a bandwidth of 400 MHz, e.g. ⅛ of carrier bandwidth at lower frequency location. Note that CRB 0˜CRB 274 for 120 KHz corresponds to CRB 0˜CRB 35 for 960 kHz in the frequency domain. In other words, a bandwidth part with lower subcarrier spacing would occupy only frequency resource of a carrier with lower frequency location, e.g. starting with respective of Point A or CRB 0. It is not allowed to allocate frequency resource of a carrier with higher frequency location to bandwidth part with lower subcarrier spacing. As a result, allocating resource for UE with different subcarrier spacing, e g. corresponding to their active bandwidth part, would not be equally split across a carrier bandwidth at least for a lower subcarrier spacing. A UE with (active) bandwidth part with lower subcarrier spacing would be confined within lower frequency location.

A general concept of this invention is that a frequency location of a bandwidth part is extended. A frequency location of the bandwidth part can be extended to more be than 275*8 offset. A CRB with index larger than 274 could be assigned to a bandwidth part. The CRB is in a subcarrier spacing of the bandwidth part.

A first or lowest CRB that can be assigned by locationAndBandwidth field could be a CRB different from CRB 0. A base station indicates a first or lowest CRB that can be assigned by locationAndBandwidth field. For example, the base station could indicate a first or lowest CRB that can be assigned by locationAndBandwidth field for a bandwidth part is CRB X.

A base station could indicate an offset value X. A locationAndBandwidth field could allocate resource within CRB X˜RB X+274. The locationAndBandwidth field for the bandwidth part could indicates a (starting) CRB/Physical Resource Block (PRB) Y and a Length of Z CRBs/PRBs. The bandwidth part would occupy CRB X+Y˜CRB X+Y+Z−1. CRB could be in subcarrier spacing of the bandwidth part. With introduction of different starting CRB or offset values, locationAndBandwidth field could allocate resource outside CRB 0˜CRB 274.

A CRB 0 of a bandwidth part could be derived from a second frequency location or position, e.g. Point B. Point B could be different from Point A. A base station could indicate Point B to a UE. The base station could inform a UE which of Point A and Point B is used to derive the frequency resource allocated to a bandwidth part. Point B could be derived from Point A, e.g. base station indicates an offset value between Point A and Point B. Point B could be derived from frequency location of SSB, e.g. base station indicates an offset value between frequency location of SSB and Point B. CRB 0 could be in subcarrier spacing corresponding to the bandwidth part. There would be two frequency locations or positions for CRB 0, one corresponds to Point A and the other corresponds to Point B. The UE could determine which of the two frequency locations or positions for CRB 0 is used based on which of Point A and Point B is used for the bandwidth part.

A frequency location , e.g. a first PRB or a lowest PRB, of a bandwidth part could be extended via a reference subcarrier spacing. The reference subcarrier spacing could be different from a subcarrier spacing of the bandwidth part. The reference subcarrier pacing could be larger than a subcarrier spacing of the bandwidth part. The reference subcarrier spacing could be used to interpret frequency location and/or bandwidth of the bandwidth part. For example, using a reference subcarrier spacing of 960 kHz to interpret a frequency location and/or bandwidth of a bandwidth part with 120 kHz can indicate resource across 275*8 PRB (in 120 kHz) for the bandwidth part. The reference subcarrier spacing could be indicated by the base station.

For example, when a reference subcarrier spacing for a 120 kHz bandwidth part is 960 kHz, a “locationAndBandwidth” field for the bandwidth part could be interpreted by 960 kHz (rather than 120 kHz). The locationAndBandwidth field could point to a first CRB/PRB (in 960 kHz) and a number of CRBs/PRBs (e.g. X CRBs/PRBs in 960 kHz) for the bandwidth part. The locationAndBandwidth field could point to CRB 81˜CRB 100 (in 960 kHz) (e.g. by setting a starting PRB 81 and length 20). After the frequency location and bandwidth is derived, the PRB could then be translated to 120 kHz. The number of PRB in 120 kHz would be X*8. The number of bandwidth could exceed 275. The first PRB in 120 kHz of the bandwidth part could be a PRB (in 120 kHz) which is closest (e.g. in frequency domain with starting position) to the first PRB (in 960 kHz) pointed by the locationAndBandwidth field. CRB 81˜CRB 100 (in 960 kHz) assigned by locationAndBandwidth field could be translated to CRB in 120 kHz. CRB in 120 kHz which is covered by CRB 81˜CRB 100 (in 960 kHz) could be assigned to the bandwidth part.

For example, CRB81*8˜CRB100*8 (i.e. CRB 648˜CRB800) is assigned to the bandwidth part. Alternatively, CRB 81 in 960 kHz is translated to a closest CRB in 120 kHz, e.g. CRB 648 in 120 kHz. Alternatively or additionally, CRB 100 in 960 kHz is translated to a closest CRB in 120 kHz, e.g. CRB 800 in 120 kHz. CRB between a closest CRB in 120 kHz of CRB 81 in 960 kHz and a closest CRB in 120 kHz of CRB 100 in 960 kHz, e.g. CRB 648˜CRB 800 in 120 kHz is assigned to the bandwidth part. Alternatively or additionally, a length of 20 CRB in 960 kHz is translated to 20*8, i.e. 160, CRB in 120 kHz. CRBs starting from a closest CRB in 120 kHz of CRB 81 in 960 kHz with a length of 160 CRB, e.g. CRB648˜CRB807 in 120 kHz, is assigned to the bandwidth part.

A frequency location, e.g. a first PRB or a lowest PRB, of a bandwidth part could be extended by adding more bit(s) for the locationAndBandwidth field for the bandwidth part. With more bit(s) introduced, the locationAndBandwidth field could cover a wider range of CRBs, e.g. CRB0˜CRB X where X is larger than 275. For example, X could be an integer multiple of 275. X could be 275*2^{m}. For example, X could be an (integer multiple of 275)−1. X could be 275*2^{m}−1. The locationAndBandwidth field could indicate a bandwidth part starts from CRB Y where Y is larger than 275. For example, the locationAndBandwidth field could cover CRB 0˜CRB 275*2^{m}. The locationAndBandwidth field could be interpreted as resource indicator value (RIV) with N_{BWF}^{size}=X.

A frequency location, e.g. a first PRB or a lowest PRB, of a bandwidth part could be extended by increasing a value rage of offsetToCarrier. A frequency location, e.g. a first PRB or a lowest PRB, of a bandwidth part could be extended by indicating a second offset (e.g. in addition to offsetToCarrier). The UE can derive a Point A based on offsetToCarrier and frequency location of SSB. The UE can derive a point B based on Point A and the second offset value. The UE can derive a point B based on offsetToCarrier, frequency location of SSB and the second offset value. The (frequency location of) bandwidth part can be derived relative to point A. The (frequency location of) bandwidth part can be derived relative to point B.

A base station could indicate which of Point A or Point B is used for a bandwidth part. An initial bandwidth part could be associated with Point A only. A BWP configured by dedicated RRC signaling could be associated with Point B. With introduction of Point B, frequency location of a bandwidth part can be extended. The first or lowest PRB of a bandwidth part can start from a wider range of frequency location or position.

A frequency location, e.g. a first PRB or a lowest PRB, of a bandwidth part could be extended by a different starting CRB indicated by the locationAndBandwidth field. Currently, the locationAndBandwidth field could indicate frequency resource starting from CRB0 (e.g. among candidates CRB0˜CRB274). The locationAndBandwidth field could indicate frequency resource starting from CRB X. X could be larger than 0. X could be larger than 274. The locationAndBandwidth field could indicate frequency resources among candidates CRB X CRB Y. Y is larger than X. Y could be larger than 274. Y could be X+274. A value of X could be indicated by a base station. A value of Y could be indicated by a base station. The locationAndBandwidth field could be interpreted with the value X. A base station could indicate a first or lowest CRB that can be allocated by the locationAndBandwidth field. The first or lowest CRB could be CRB X.

A bandwidth of a bandwidth part of may not be allowed to be more than a value X. A bandwidth of a bandwidth part of may be more than a value X. X could be 275 PRBs (in a subcarrier spacing of the bandwidth part). In one embodiment, a UE could receive a configuration of a bandwidth part from a base station. The configuration may comprise a location and a bandwidth of the bandwidth part. The location and the bandwidth could be indicated by a locationAndBandwidth field. The bandwidth part may comprise at least one CRB with index larger than 274. The bandwidth part may comprise at least one frequency resource corresponding to CRB with index larger than 274. The location could indicate frequency location of a first CRB/PRB of the bandwidth part.

In another embodiment, a base station could transmit a configuration of a bandwidth part to a UE. The configuration may comprise a location and a bandwidth of the bandwidth part for the UE. The location and the bandwidth could be indicated by a locationAndBandwidth field. The bandwidth part may comprise at least one CRB with index larger than 274. The bandwidth part may comprise at least one frequency resource corresponding to CRB with index larger than 274. The location could indicate frequency location of a first CRB/PRB of the bandwidth part.

A lowest CRB/PRB that can be indicated by the location could be indicated by the base station. A lowest CRB/PRB that can be indicated by the location could be indicated by the base station and may not be CRB 0. A lowest CRB/PRB that can be indicated by the location could be indicated by an offset value. For example, an offset value X could be used to indicate CRB X is the lowest CRB/PRB that can be indicated by the location. The location could indicate that the Yth CRB is allocated to the bandwidth part. The first CRB/PRB of the bandwidth part could be indicated by the location and the lowest CRB/PRB that can be indicated by the location. The first CRB/PRB of the bandwidth part could be indicated by the location and the offset value. The first CRB/PRB of the bandwidth part could be a CRB with an index larger than 274. The locationAndBandwidth field could indicate frequency resource for the bandwidth part within CRB X˜CRB Z. X could be larger than 0. Z could be X+274. Z could be indicated by a base station. The locationAndBandwidth field could indicate frequency resource for the bandwidth part within CRB 0˜CRB Z. Bandwidth of the bandwidth part may not be more than 275 PRBs. Alternatively, bandwidth of the bandwidth part may be more than 275PRBs. The CRB/PRB could be in a subcarrier spacing of the bandwidth part.

In another embodiment, a UE could receive a configuration of a bandwidth part. The configuration comprises a location and a bandwidth of the bandwidth part. The location and the bandwidth could be indicated by a locationAndBandwidth field. The UE may not interpret the locationAndBandwidth field based on a subcarrier spacing of the bandwidth part. The UE could interpret the locationAndBandwidth field based on a reference subcarrier spacing.

In another embodiment, a base station could transmit a configuration of a bandwidth part. The configuration may comprise a location and a bandwidth of the bandwidth part. The location and the bandwidth could be indicated by a locationAndBandwidth field. The base station may not interpret, indicate, set, or calculate the locationAndBandwidth field based on a subcarrier spacing of the bandwidth part. The base station may interpret, indicate, set, or calculate the locationAndBandwidth field based on a reference subcarrier spacing.

The reference subcarrier spacing could be different from a subcarrier spacing of the bandwidth part. The reference subcarrier spacing could be larger than a subcarrier spacing of the bandwidth part. The reference subcarrier spacing could be indicated by the base station. The UE could derive a first set of CRB(s) in the reference subcarrier spacing. The first set of CRB(s) could be indicated by locationAndBandwidth field.

The UE could determine a second set of CRB(s) in the subcarrier spacing of the bandwidth part based on the first set of CRB(s). The second set of CRB(s) could be associated with the first set of CRB(s). The second set of CRB(s) could occupy the same or similar frequency resources as the first set of CRB(s). The second set of CRB(s) could be closed to the first set of CRB(s) in frequency domain.

A first or lowest PRB/CRB of the second set of CRB(s) could be derived based on a first or lowest PRB/CRB of the first set of CRB(s). A first or lowest PRB/CRB of the second set of CRB(s) could be a PRB/CRB in a subcarrier spacing of the bandwidth part closest to a first or lowest PRB/CRB of the first set of CRB(s). A first or lowest PRB/CRB of the second set of CRB(s) could be a PRB/CRB in a subcarrier spacing of the bandwidth part on a same or similar frequency as a frequency of a first or lowest PRB/CRB of the first set of CRB(s). A first or lowest PRB/CRB of the second set of CRB(s) could be a PRB/CRB in a subcarrier spacing of the bandwidth part on a same or similar frequency as a frequency of a first or lowest PRB/CRB of the first set of CRB(s). A first/lowest PRB/CRB of the second set of CRB(s) could be a highest PRB/CRB in a subcarrier spacing of the bandwidth part with frequency lower than a frequency of a first or lowest PRB/CRB of the first set of CRB(s). A first or lowest PRB/CRB of the second set of CRB(s) could be a lowest PRB/CRB in a subcarrier spacing of the bandwidth part with frequency higher than a frequency of a first/lowest PRB/CRB of the first set of CRB(s).

A last or highest PRB/CRB of the second set of CRB(s) could be derived from the first or lowest PRB/CRB of the second set of CRB(s). A last or highest PRB/CRB of the second set of CRB(s) could be derived from a bandwidth of the first set of CRB(s). A last or highest PRB/CRB of the second set of CRB(s) could be derived from a bandwidth of the first set of CRB(s) and a difference between the reference subcarrier spacing and a subcarrier spacing of the bandwidth part. A last or highest PRB/CRB of the second set of CRB(s) could be derived from a first or lowest PRB/CRB of the second set of CRB(s), and/or a bandwidth of the first set of CRB(s), and/or a difference between the reference subcarrier spacing and a subcarrier spacing of the bandwidth part. A bandwidth of the second set of CRB(s) could be derived from a bandwidth of the first set of CRB(s) and/or a difference between the reference subcarrier spacing and a subcarrier spacing of the bandwidth part.

A last or highest PRB/CRB of the second set of CRB(s) could be derived based on a last or highest PRB/CRB of the first set of CRB(s). A last or highest PRB/CRB of the second set of CRB(s) could be a PRB/CRB in a subcarrier spacing of the bandwidth part closest to a last or highest PRB/CRB of the first set of CRB(s). A last or highest PRB/CRB of the second set of CRB(s) could be a PRB/CRB in a subcarrier spacing of the bandwidth part on a same or similar frequency as a frequency of a last or highest PRB/CRB of the first set of CRB(s). A last or highest PRB/CRB of the second set of CRB(s) could be a PRB/CRB in a subcarrier spacing of the bandwidth part on a same or similar frequency as a frequency of a last or highest PRB/CRB of the first set of CRB(s). A last or highest PRB/CRB of the second set of CRB(s) could be a highest PRB/CRB in a subcarrier spacing of the bandwidth part with frequency lower than a frequency of a last or highest PRB/CRB of the first set of CRB(s). A last or highest PRB/CRB of the second set of CRB(s) could be a lowest PRB/CRB in a subcarrier spacing of the bandwidth part with frequency higher than a frequency of a last or highest PRB/CRB of the first set of CRB(s).

The bandwidth part may comprise the second set of CRB(s). The bandwidth part may consist of the second set of CRB(s). The bandwidth part could cover or occupy the second set of CRB(s). The bandwidth part may comprise at least one CRB with index larger than 274. The second set of CRB(s) may comprise at least one CRB with index larger than 274. A first or lowest CRB of the second set of CRB(s) could be CRB with index larger than 274. The bandwidth part may comprise at least one frequency resource corresponding to CRB with index larger than 274. The locationAndBandwidth field could indicate the frequency location of a first CRB/PRB of the first set of CRBs. Bandwidth of the bandwidth part may not be more than 275 PRBs. Alternatively, bandwidth of the bandwidth part may be more than 275 PRBs. The CRB/PRB could be in a subcarrier spacing of the bandwidth part.

In another embodiment, a UE could receive a configuration of a bandwidth part. The configuration may comprise a location and a bandwidth of the bandwidth part. The location and the bandwidth could be indicated by a locationAndBandwidth field. The UE could receive an indication of a first frequency point, e.g. Point A. The UE could receive an indication of a second frequency point, e.g. Point B. The UE could derive the location of the bandwidth part based on a first frequency point or a second frequency point. The UE could receive an indication whether location of the bandwidth part is derived based on the first frequency point or the second frequency point.

In another embodiment, a base station could transmit a configuration of a bandwidth part to a UE. The configuration may comprise a location and a bandwidth of the bandwidth part. The location and the bandwidth could be indicated by a locationAndBandwidth field. The base station could transmit an indication of a first frequency point, e.g. Point A. The base station could transmit an indication of a second frequency point, e.g. Point B. The base station could derive, determine, or set the location of the bandwidth part based on a first frequency point or a second frequency point. The UE could receive an indication whether location of the bandwidth part is derived based on the first frequency point or the second frequency point.

The first frequency point could be a default frequency point for deriving location of bandwidth part. The first frequency point could be used for deriving location of bandwidth part if there is no indication for the base station regarding which frequency point is used. The first frequency point could be used for deriving location of a specific bandwidth part, e.g. an initial bandwidth part or a default bandwidth part. The first frequency point may correspond to a lowest frequency of a carrier or serving cell.

The second frequency point could be different from the first frequency point. The second frequency point could have a higher frequency than the first frequency point. The second frequency point could have a lower frequency than the first frequency point. The second frequency point could be derived based on the first frequency point and a first offset value. The first offset value could be a difference (in frequency) between the first frequency point and the second frequency point. The second frequency point could be derived based on a frequency of SSB and a second offset value. The second offset value could be a difference (in frequency) between the frequency of Synchronization Signal Block (SSB) and the second frequency point.

The first frequency point could be derived based on a frequency of SSB and a third offset value. The third offset value could be a difference (in frequency) between the frequency of SSB and the first frequency point. The second frequency point could be within available frequency resource for a serving cell or carrier. The second frequency point may correspond to a (specific) CRB. The second frequency point may correspond to a CRB with an inedex. The index could be indicated by the base station.

The second frequency point could be derived based on a CRB 0 associated with the first frequency point and an fourth offset value. The fourth offset value could be a difference (in frequency) between the CRB 0 associated with the first frequency point and the second frequency point. The fourth offset value could be a difference (in frequency) between the CRB 0 associated with the first frequency point and a CRB 0 associated with the second frequency point. There could be two CRB 0's associated with the two frequency points. For example, the first frequency point is associated with a first CRB 0. The second frequency point associated is with a second CRB 0 (e.g. could be denoted as CRB 0′).

There could be sets of CRBs associated with the two frequency points. The first frequency point could be associated with a first set of CRB 0˜CRB 275. The second frequency point could be associated with a second set of CRB 0˜CRB 274 (e.g. could be denoted as CRB 0′˜CRB 274′). The locationAndBandwidth field could indicate candidate frequency resource starting from the first CRB 0 if location of the bandwidth part is derived based on the first frequency point. The locationAndBandwidth field could indicate candidate frequency resource starting from the second CRB 0 if location of the bandwidth part is derived based on the second frequency point. The locationAndBandwidth field could indicate frequency resource within the first set of CRB 0˜CRB 274 if location of the bandwidth part is derived based on the first frequency point. The locationAndBandwidth field could indicate candidate frequency resource starting from the second set of CRB 0˜CRB 274 if location of the bandwidth part is derived based on the second frequency point. Bandwidth of the bandwidth part may not be more than 275 PRBs. Alternatively, bandwidth of the bandwidth part may be more than 275 PRBs. The CRB/PRB could be in a subcarrier spacing of the bandwidth part.

Throughout the invention, CRB and PRB could be a resource block. CRB could be replaced with PRB. PRB could be replaced with CRB.

Throughout the invention, a lowest CRB/PRB could be a CRB/PRB with lowest index. A lowest CRB/PRB could be a CRB/PRB with lowest frequency. A first CRB/PRB could be a CRB/PRB with lowest index. A first CRB/PRB could be a CRB/PRB with lowest frequency.

Throughout the invention, a highest CRB/PRB could be a CRB/PRB with highest index. A highest CRB/PRB could be a CRB/PRB with highest frequency. A last CRB/PRB could be a CRB/PRB with highest index. A last CRB/PRB could be a CRB/PRB with highest frequency.

Throughout the invention, a frequency (location) of a CRB/PRB could be a lowest frequency (location) of a CRB/PRB. A frequency (location) of a CRB/PRB could be a highest frequency (location) of a CRB/PRB. A frequency (location) of a CRB/PRB could be a center frequency (location) of a CRB/PRB.

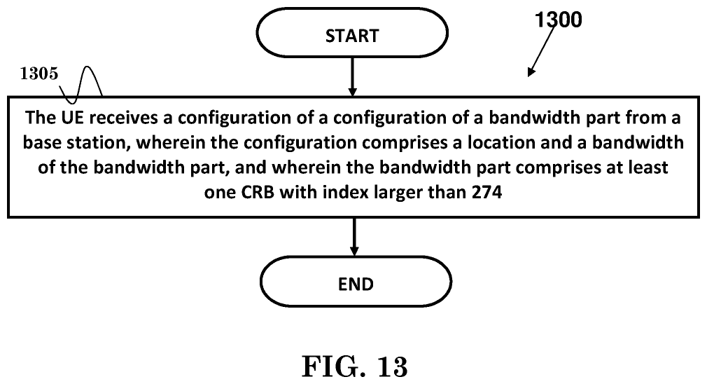

FIG. 13 is a flow chart 1300 according to one exemplary embodiment from the perspective of a UE. In step 1305, the UE receives a configuration of a configuration of a bandwidth part from a base station, wherein the configuration comprises a location and a bandwidth of the bandwidth part, and wherein he bandwidth part comprises at least one CRB with index larger than 274.

Referring back to FIGS. 3 and 4, in one exemplary embodiment of a UE. The UE 300 includes a program code 312 stored in the memory 310. The CPU 308 could execute program code 312 to enable the UE to receives a configuration of a configuration of a bandwidth part from a base station, wherein the configuration comprises a location and a bandwidth of the bandwidth part, and wherein he bandwidth part comprises at least one CRB with index larger than 274. Furthermore, the CPU 308 can execute the program code 312 to perform all of the above-described actions and steps or others described herein.

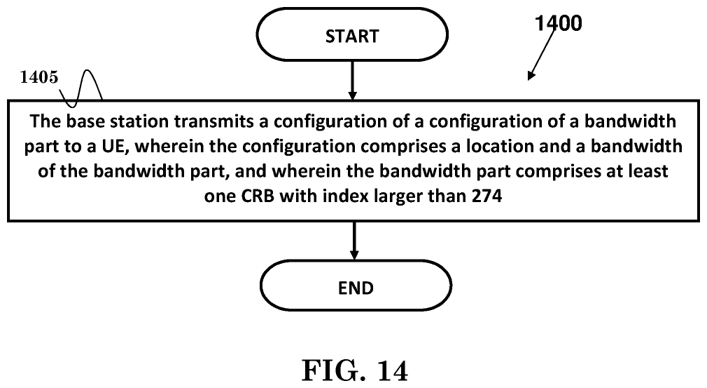

FIG. 14 is a flow chart 1400 according to one exemplary embodiment from the perspective of a base station. In step 1405, the base station transmits a configuration of a configuration of a bandwidth part to a UE, wherein the configuration comprises a location and a bandwidth of the bandwidth part, and wherein the bandwidth part comprises at least one CRB with index larger than 274.

Referring back to FIGS. 3 and 4, in one exemplary embodiment of a base station. The base station 300 includes a program code 312 stored in the memory 310. The CPU 308 could execute program code 312 to enable the base station to transmit a configuration of a configuration of a bandwidth part to a UE, wherein the configuration comprises a location and a bandwidth of the bandwidth part, and wherein the bandwidth part comprises at least one CRB with index larger than 274. Furthermore, the CPU 308 can execute the program code 312 to perform all of the above-described actions and steps or others described herein.

In the context of the embodiments illustrated in FIGS. 13-14 and discussed above, in one embodiment, the location and the bandwidth could be indicated by a locationAndBandwidth field. A lowest CRB/PRB that can be indicated by the location could be indicated by the base station. An index of a lowest CRB/PRB that can be indicated by the location could be indicated by the base station. The locationAndBandwidth field could indicate resource for the bandwidth part starting from the lowest CRB/PRB. The locationAndBandwidth field could indicate resource for the bandwidth part within or between the lowest CRB/PRB and a second CRB/PRB. The second CRB/PRB could be indicated by the base station.

In one embodiment, there could be a fixed number of CRB/PRB between the lowest CRB/PRB and the second CRB/PRB. The fixed number could be 273.

In one embodiment, the first or lowest PRB/CRB of the bandwidth part could be derived based on the locationAndBandwidth field and a lowest CRB/PRB that can be indicated by the location. The first or lowest PRB/CRB of the bandwidth part could be the lowest CRB/PRB that can be indicated by the location when locationAndBandwidth field indicate a location of (starting) PRB 0.

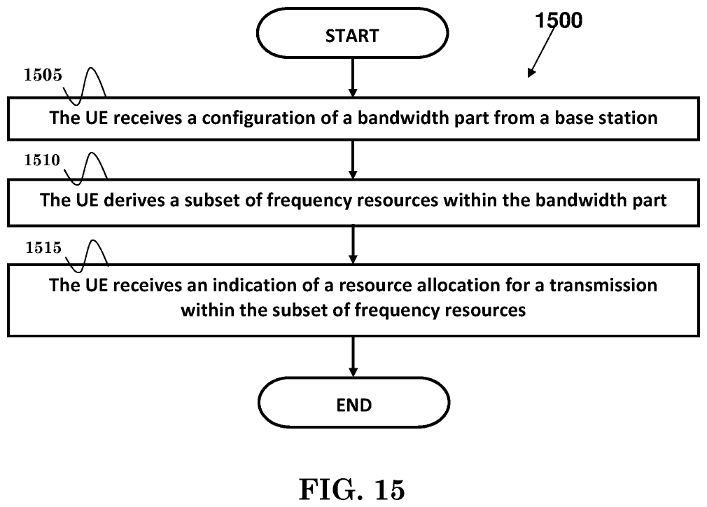

FIG. 15 is a flow chart 1500 according to one exemplary embodiment from the perspective of a UE. In step 1505, the UE receives a configuration of a bandwidth part from a base station. In step 1510, the UE derives a subset of frequency resources within the bandwidth part. In step 1515, the UE receives an indication of a resource allocation for a transmission within the subset of frequency resources.

Referring back to FIGS. 3 and 4, in one exemplary embodiment of a UE. The UE 300 includes a program code 312 stored in the memory 310. The CPU 308 could execute program code 312 to enable the communication device (i) to receive a configuration of a bandwidth part from a base station, (ii) to derive a subset of frequency resources within the bandwidth part, and (iii) to receive an indication of a resource allocation for a transmission within the subset of frequency resources. Furthermore, the CPU 308 can execute the program code 312 to perform all of the above-described actions and steps or others described herein.

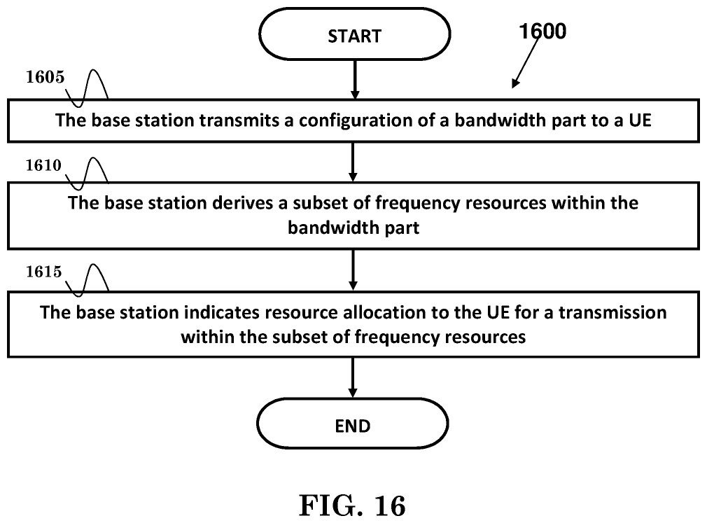

FIG. 16 is a flow chart 1600 according to one exemplary embodiment from the perspective of a base station. In step 1605, the base station transmits a configuration of a bandwidth part to a UE. In step 1610, the base station derives a subset of frequency resources within the bandwidth part. In step 1615, the base station indicates resource allocation to the UE for a transmission within the subset of frequency resources.

Referring back to FIGS. 3 and 4, in one exemplary embodiment of a base station. The base station 300 includes a program code 312 stored in the memory 310. The CPU 308 could execute program code 312 to enable the communication device (i) to transmit a configuration of a bandwidth part to a UE, (ii) to derive a subset of frequency resources within the bandwidth part, and (iii) to indicate resource allocation to the UE for a transmission within the subset of frequency resources. Furthermore, the CPU 308 can execute the program code 312 to perform all of the above-described actions and steps or others described herein.

In the context of the embodiments illustrated in FIGS. 15 and 16 and discussed above, in one embodiment, resources allocated for the transmission could be part of the subset of frequency resources. Resource allocation for the transmission could be indicated by a DCI. A size of a resource allocation field in the DCI could be determined based on a bandwidth of the subset of frequency resources.

In one embodiment, the base station could indicate frequency location of the subset of frequency resources to the UE. The base station could indicate bandwidth of the subset of frequency resources to the UE. The base station may not be allowed to schedule the UE outside the subset of frequency resources.

In one embodiment, maximum bandwidth of the UE could be smaller than bandwidth of the bandwidth part. The transmission could be for a data channel. Bandwidth of the subset of frequency resources could be fixed or pre-defined.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a User Equipment (UE), comprising:
the UE receives a configuration of a bandwidth part from a base station;
the UE derives a subset of frequency resources within the bandwidth part; and
the UE receives an indication of a resource allocation for a transmission within the subset of frequency resources.

2. The method of claim 1, resources allocated for the transmission are part of the subset of frequency resource(s).

3. The method of claim 1, resource allocation for the transmission is indicated by a Downlink Control Information (DCI).

4. The method of claim 3, a size of a resource allocation field in the DCI is determined based on a bandwidth of the subset of frequency resource(s).

5. The method of claim 1, frequency location of the subset of frequency resource(s) is indicated to the UE.

6. The method of claim 1, bandwidth of the subset of frequency resource(s) is indicated to the UE.

7. The method of claim 1, the UE is not allowed to be scheduled outside the subset of frequency resources.

8. The method of claim 1, maximum bandwidth of the UE is smaller than bandwidth of the bandwidth part.

9. The method of claim 1, the transmission is for a data channel.

10. The method of claim 1, bandwidth of the subset of frequency resource(s) is fixed or pre-defined.

11. A method of base station, comprising:
the base station transmits a configuration of a bandwidth part to a User Equipment (UE);
the base station derives a subset of frequency resources within the bandwidth part; and
the base station indicates resource allocation to the UE for a transmission within the subset of frequency resources.

12. The method of claim 11, resources allocated for the transmission are part of the subset of frequency resources.

13. The method of claim 11, resource allocation for the transmission is indicated by a Downlink Control Information (DCI).

14. The method of claim 13, a size of a resource allocation field in the DCI is determined based on a bandwidth of the subset of frequency resources.

15. The method of claim 11, the base station indicates frequency location of the subset of frequency resources to the UE.

16. The method of claim 11, the base station indicates bandwidth of the subset of frequency resources to the UE.

17. The method of claim 11, the base station is not allowed to schedule the UE outside the subset of frequency resources.

18. The method of claim 11, maximum bandwidth of the UE is smaller than bandwidth of the bandwidth part.

19. The method of claim 11, the transmission is for a data channel.

20. The method of claim 11, bandwidth of the subset of frequency resources is fixed or pre-defined.
